(19) United States
(12) Patent Application Publication
(10) Pub. No.: US 2012/0328756 A1
(43) Pub. Date: Dec. 27, 2012

(54) CONFECTIONERY PRODUCTS CONTAINING ERYTHRITOL

(75) Inventors: An Amanda Jules Heylen, Zemst (BE); Ronny Leontina Marcel Vercauteren, Beveren (BE)

(73) Assignee: Cargill, Inc., Wayzata, MN (US)

(21) Appl. No.: 13/582,159

(22) PCT Filed: Feb. 24, 2011
(86) PCT No.: PCT/EP11/00887

§ 371 Date: Aug. 31, 2012

(30) Foreign Application Priority Data
Mar. 4, 2010 (EP) 10002197.1

(51) Int. Cl. A23G 3/38

(52) U.S. Cl. 426/548; 426/520

(57) ABSTRACT

The present invention relates to a confectionery product, more specifically a hard candy containing an edible acid, and at least 95% w/w erythritol preferably at least 98% w/w erythritol, more preferably at least 99% w/w erythritol. The confectionery product is not containing a binding agent selected from the group consisting of gum Arabic, gelatine and mixtures thereof.

### FIELD OF THE INVENTION

The present invention relates to a confectionery product containing edible acids, and at least 95% w/w erythritol.

### BACKGROUND OF THE INVENTION

Recent developments in confectionery manufacture have been the replacement of part or all of the sugar by sugar alcohol (polyol) in the interest of providing a product having a reduced calorie content and a lower tendency to cause tooth decay. Among the polyols which have been proposed for the manufacture of confectionery are isomalt, maltitol, xylitol, erythritol and mixtures thereof.

EP 0 533 334 describes a process for the production of hard candy characterized in that the maltitol content of the sugar alcohol mixture is more than 77% but less than 86% by weight based on dry substance.

U.S. Pat. No. 4,971,798 describes a hard confection based upon hydrogenated isomaltulose (=isomalt).

U.S. Pat. No. 4,883,685 describes a hard candy which comprises erythritol and saccharides selected from among sugars and sugar alcohols other than erythritol as well as a process for producing the hard candy.

JP 3100186 describes an erythritol based candy which is further containing a hydrocolloid.

There is still a further need of having a confectionery product which is based upon polyols and is sugar free.

### SUMMARY OF THE INVENTION

The current invention relates to a confectionery product selected from the group consisting of hard candy, brittle, caramel and toffee and said confectionery product is containing an edible acid, and at least 95% w/w erythritol preferably at least 98% w/w erythritol, more preferably at least 99% w/w erythritol. More specifically it relates to a hard candy consisting of an edible acid, 95-99% w/w erythritol, flavours, high-intensity sweeteners, and/or colouring agents.

Furthermore the current invention relates to a process for preparing a confectionery product by heating at a temperature from 120 to 160° C. an erythritol-containing mixture wherein the dry matter is containing an edible acid and at least 95% w/w erythritol.

### DETAILED DESCRIPTION

The current invention relates to a confectionery product selected from the group consisting of hard candy, brittle, caramel and toffee and said confectionery product is containing an edible acid, and at least 95% w/w erythritol, preferably at least 98% w/w erythritol, more preferably at least 99% w/w erythritol. It relates to a confectionery product selected from the group consisting of hard candy, brittle, caramel and toffee and said confectionery product is containing an edible acid, and at least 95% w/w erythritol, preferably at least 98% w/w erythritol, more preferably at least 99% w/w erythritol and it is not containing a binding agent (equivalent wording is binder) selected from the group consisting of gum Arabic, gelatine and mixtures thereof. It relates to a confectionery product selected from the group consisting of hard candy, brittle, caramel and toffee and said confectionery product is containing an edible acid, and at least 95% w/w erythritol, preferably at least 98% w/w erythritol, more preferably at least 99% w/w erythritol, and it is further comprising flavours, and/or high-intensity sweeteners and/or colouring agents, and it is not containing a binding agent (equivalent wording is binder) selected from the group consisting of gum Arabic, gelatine and mixtures thereof. More specifically it relates to a hard candy consisting of an edible acid, 95-99% w/w erythritol, flavours, and/or colouring agents. Furthermore, it relates to a hard candy consisting of an edible acid, 95-99% w/w erythritol, flavours, high-intensity sweeteners and/or colouring agents. The current invention relates to a confectionery product which is not a lozenge, since it is not containing a binding agent selected from the group consisting of gum Arabic, gelatine and mixtures thereof.

Erythritol is a carbohydrate-based polyol (sugar alcohol), i.e.; a tetriitol represented by the chemical formula C₄H₁₀O₄ and which has an excellent appearance in the form of white crystals and it is similar to the appearance of granulated sugar, sucrose. It is highly soluble in water, non-digestive, providing zero calories and is non cariogenic.

Furthermore, the confectionery product is comprising an edible acid. Suitable acids are selected from the group consisting of malic acid, fumaric acid, lactic acid, tartaric acid, glucono-delta lactone, gluconic acid, phosphoric acid, succinic acid, adipic acid, ascorbic acid, acetic acid, citric acid, their corresponding salts and mixture of two or more thereof.

Preferably citric acid is used as edible acid. The acids are added in a quantity based on dry matter of the confectionery product in an amount of 0.2 to 5%, preferably from 0.2 to 2%, more preferably from 0.2% to 1%.

The confectionery product further comprises flavours, high-intensity sweeteners, colouring agents or a mixture of two or more thereof.

The flavours are mint flavour, chocolate mint flavour, bubblegum flavour, apple spice flavour, black cherry flavour, pineapple flavour, cola flavour, grape flavour, cherry flavour, apple flavour and citrus flavours such as orange flavour, lemon flavour, lime flavour, fruit punch, mixtures of two or more thereof and the like. The amount of flavour depends upon the flavour or flavours selected, the flavour impression desired and the form of flavour used.

A high-intensity sweetener, which can be used as non-nutritive sweetener can be aspartame, acesulfame salts such as acesulfame-K, saccharins (e.g. sodium and calcium salts), cyclamates (e.g. sodium and calcium salts), sucralose, alitame, neotame, steviosides, glycyrrhizin, neohesperidin dihydrochalcone, monellin, thaumatin, brazzein, mixtures of two or more thereof, and the like. Actually any other natural derived high-intensity sweetener is suitable as well.

If desired, colouring agents can also be added as well. Any water-soluble colouring agent approved for food use can be utilized for the current invention.

In a specific embodiment, the current invention relates to a hard candy consisting of an edible acid, at least 95% w/w erythritol, preferably at least 98% w/w erythritol, more preferably at least 99% w/w erythritol, flavours, high-intensity sweeteners and/or colouring agents. More preferably the confectionery product is a hard candy which is consisting of an edible acid, at least 95% w/w erythritol, preferably at least 98% w/w erythritol, more preferably at least 99% w/w erythritol, and flavours, high-intensity sweetener, colouring agents or a mixture of two or more thereof (mixture of flavours, colouring agents and/or high- intensity sweeteners).

The current invention relates to a process for preparing the confectionery product of the current invention by heating at a temperature from 120 to 160° C. an erythritol-containing mixture wherein the dry matter is containing an edible acid and at least 95% w/w erythritol.

The process is further characterised in that at the end of the heating period a vacuum of 0.6 to 0.8 bar is applied.

Finally the confectionery product is sugar free, provides zero calories and can be labeled as natural and/or organic.

Disadvantages such as uneven crystallization, uneven surface, grainy sandy texture and brittleness have been overcome by the confectionery product of the current invention.

The invention will hereunder be illustrated in the form of the following examples.

### Examples

### Analytical Methods

Texture analysis was conducted on the Stable Microsystems equipment, TA-XT plus Texture Analyzer. The program setting was as follows:
TA Mode: Measure Force in Compression
TA Option: Return to Start
Pre-Test Speed: 1.0 mm/s
Test Speed: 1.0 mm/s
Post Speed: 10.0 mm/s
Test Distance: 4.0 mm
Trigger Value: 50 g
PPS: 400.00
Probe: 2 mm Cylinder Probe (P/2) using a 30 kg load cell
Accessory: Heavy Duty Platform (HDP/90)

### Results: Force (g) (Hardness)

Distance (mm) (Fracturability)

Sample Preparation: All samples were allowed to equilibrate at controlled temperature of 20° C. and were then removed from the place of storage just prior to testing.

Test Set Up: The HDP/90 was secured onto the machine base. The probe was calibrated prior to testing the samples. The sample were placed on the blank plate of the HDP/90 and positioned centrally under the probe. The penetration test was commenced.

Two characteristics were tested on the texture analyzer; hardness and fracturability. Below are definitions from Texture Technology on hardness and fracturability.

Hardness is the peak force of the first compression of the candy. Not all products fracture; but when they do, the fracturability point occurs where the plot has its first significant peak (where the force falls off) during the probe's first compression of the product.

Hardness and fracturability are two completely different parameters that are not comparable with each other.

### Example 1

### Recipe

Following recipes were tested:
99 w/w% erythritol (Cargill Eridex 16954) 1 w/w% citric acid monohydrate (Merck 244) or
98 w/w% erythritol (Cargill Eridex 16954) 2 w/w% citric acid monohydrate (Merck 244)

A recipe with 100% erythritol (Cargill Eridex 16954) was included as reference.

### Cooking and Shaping—Method

Comelts of Erythritol with 0%, 1% and 2% Citric Acid Monohydrate were prepared:
50 g, 49.5 g and 49 g erythritol was weighed in 250 ml Duran flasks with stopper. The Duran flasks were put in an oil bath at 160° C. for 15 minutes until the erythritol was melted, the flask was swirled regularly.
(0 g), 0.5 g and 1 g Citric Acid Monohydrate were added to the melted erythritol in the corresponding flask. The flask was swirled to dissolve the Citric Acid Monohydrate
Aliquots of 3.02 ml (=3.7g) were sampled with a Gilson 5 ml pipet and transferred to a mould
The formed hard candies were removed from the mould once they had cooled down.

### Measurement

| | Citric Acid | | Distance |
|---|---|---|---|
| Comelt | Monohydrate (%) | Force (kg) | (mm) |
| erythritol + Citric Acid | 0 | 11 | 0.42 |
| Monohydrate | 1 | 12 | 0.44 |
| | 2 | 20 | 0.71 |

The analytical results showed that the hard candies containing Citric Acid Monohydrate had a hard texture and did not break easily.

1.-6. (canceled)

7. A confectionery product selected from the group consisting of hard candy, brittle, caramel and toffee, the confectionery product comprising an edible acid and at least 95% w/w erythritol.

8. The confectionery product of claim 1, wherein the product further comprises at least one of a flavor, a high-intensity sweetener, and a coloring agent.

9. The confectionery product of claim 1, wherein the confectionery product is a hard candy consisting of 95-99% w/w erythritol, an edible acid, and a flavor and/or a coloring agent.

10. The confectionery product of claim 1, wherein the confectionery product is a hard candy consisting of 95-99% w/w erythritol, an edible acid, and at least one of a high-intensity sweetener, a flavor, a coloring agent, and mixtures thereof.

11. A process for preparing the confectionery product of claim 1, the process comprising:
heating an erythritol-containing mixture at a temperature of from 120° C. to 160° C.,
wherein the mixture comprises an edible acid and at least 95% w/w erythritol.

12. The process of claim 11, wherein at the end of a heating period a vacuum of 0.6 to 0.8 bar is applied.
